(19) United States
(12) Patent Application Publication
(10) Pub. No.: US 2016/0292562 A1
(43) Pub. Date: Oct. 6, 2016

(54) TOY

(71) Applicant: NINTENDO CO., LTD., Kyoto (JP)

(72) Inventors: Kenichiro ASHIDA, Kyoto (JP); Emi WATANABE, Kyoto (JP); Yasuhiro INOUE, Kyoto (JP); Yusuke KANEDA, Kyoto (JP)

(21) Appl. No.: 14/818,696

(22) Filed: Aug. 5, 2015

(30) Foreign Application Priority Data
Mar. 31, 2015 (JP) 2015-071694

(51) Int. Cl. G06K 19/077; A63H 3/36

(52) U.S. Cl. CPC G06K 19/07758; A63H 3/36

(57) ABSTRACT

A non-limiting example toy is a toy of a soft toy type, and includes an outer cover and filler that is filled inside the outer cover. A buttock portion of a stuffed toy is formed with a flat surface or approximately flat surface, and an ornament member is sewn on a surface side of the outer cover. A reinforcing member is adhered on a back side of the outer cover in a position corresponding to the ornament member. An IC tag is stuck on this reinforcing member. A user passes the stuffed toy over a reader/writer by bringing the buttock portion (hips portion) of the stuffed toy providing with the ornament member into contact to the reader/writer or by putting (sitting down) the stuffed toy on the reader/writer. Accordingly, tag information is read or tag information is rewritten.

### CROSS REFERENCE OF RELATED APPLICATION

The disclosure of the patent application No. 2015-071694 filed on Mar. 31, 2015 is incorporated by reference.

### FIELD

This application describes specifically a toy comprising an IC tag, for example.

### SUMMARY

It is a primary object of an embodiment(s) to provide a novel toy.

It is another object of an embodiment(s) to provide a toy capable of preventing damage of an IC tag even if an outer cover is formed with a relatively soft material.

A first embodiment is a stuffed toy, comprising; an IC tag; a reinforcing member; and an outer cover. The IC tag is stuck on the reinforcing member. This reinforcing member is formed with a first material that has hardness that is harder to bend than at least the IC tag. The outer cover fixes the reinforcing member thereon, and is formed with a second material softer than the first material. The reinforcing member is fixed to a back side of the outer cover corresponding to a placement portion of the stuffed toy when placing the stuffed toy on a plane surface.

According to the first embodiment, since the IC tag is stuck on the reinforcing member, even if the outer cover is of a soft material, it is possible to prevent the IC tag from bending by a force from an outside. That is, the IC tag can be prevented from being damaged. Furthermore, since the reinforcing member is fixed to the back side of the placement portion of the stuffed toy when placing the stuffed toy on a plane surface, the user can operate the stuffed toy intuitively such that the placement portion thereof can be passed over a reader/writer, whereby transmission/reception of tag information on the IC tag can be performed with the reader/writer.

A second embodiment is according to the first embodiment, wherein the placement portion of the stuffed toy when placing the stuffed toy on a plane surface is formed so as to become a flat surface or approximately flat surface.

According to the second embodiment, since the stuffed toy is passed over the reader/writer by bringing the flat surface of the stuffed toy into contact to a plane surface of the reader/writer or by placing the flat surface of the stuffed toy on a plane surface of the reader/writer, the user can operate the stuffed toy intuitively.

A third embodiment is according to the first embodiment, wherein the reinforcing member is fixed to a back side of the buttock portion of the stuffed toy.

According to the third embodiment, it is possible to transmit and receive the tag information of the IC tag by operating the stuffed toy so as to be sat down. Therefore, the user can operate the stuffed toy intuitively.

A fourth embodiment is according to the first embodiment, and further comprises an index that is provided on a surface side of the outer cover corresponding to the reinforcing member.

According to the fourth embodiment, since the index is provided, when the user passes the stuffed toy over the reader/writer in order to transmit and receive the tag information, it is possible to derive to turn a portion that the index is provided to the reader/writer or to bring the portion into contact with the reader/writer.

A fifth embodiment is according to the fourth embodiment, wherein the index is formed by an ornament member that is a separate member fixed to the outer cover.

According to the fifth embodiment, since the ornament member that is a separate member is provided, it is easy for the user to recognize it as an index.

A sixth embodiment is according to the fifth embodiment, wherein the reinforcing member is adhered to a portion that the ornament member is provided of a back side of the outer cover.

According to the sixth embodiment, if providing the ornament member such as an emblem or applique, for example, it is possible to prevent an adhesive from leaking to the surface side of the outer cover when the reinforcing member is fixed with the adhesive.

A seventh embodiment is according to the first embodiment, wherein the reinforcing member is fixed to a back side of the outer cover, and the IC tag is stuck on a surface opposite to a surface facing the outer cover among surfaces of the reinforcing member when fixed to the outer cover.

According to the seventh embodiment, since the IC tag is stuck on a surface opposite to the surface facing the outer cover among the surfaces of the reinforcing member, at least the outer cover and the reinforcing member are provided between the IC tag and the surface side of the stuffed toy, and therefore, it is possible to render the stuffed toy structure that the IC tag is hard to receive a force from an outside or to come in contact from an outside.

An eighth embodiment is according to the first embodiment, wherein the IC tag is an IC tag with a viscous agent.

According to the eighth embodiment, since the IC tag may be only stuck on the reinforcing member, fixation of the IC tag is easy.

A ninth embodiment is according to the first embodiment, and further comprises filler that is filled inside the outer cover.

According to the ninth embodiment, the stuffed toy can be constructed with the filler that is filled inside the outer cover.

A tenth embodiment is according to the ninth embodiment, wherein a material of the filler is acrylic or polyester.

An eleventh embodiment is according to the first embodiment, wherein the reinforcing member is a plate-like member.

According to the eleventh embodiment, since the reinforcing member is a plate-like member, it is possible to lessen a relatively hard portion as much as possible in the stuffed toy that can be deformed by a user's hand.

A twelfth embodiment is according to the first embodiment, wherein the reinforcing member is formed in a polygon with rounded corners or a circle.

According to the twelfth embodiment, it is possible to prevent the outer cover from being torn by the reinforcing member.

A thirteenth embodiment is according to the first embodiment, wherein the first material has hardness that can prevent the IC tag from bending in a state where the IC tag is stuck on the reinforcing member.

According to the thirteenth embodiment, since the IC tag can be prevented from bending, it is possible to prevent the IC tag from being damaged.

A fourteenth embodiment is according to the first embodiment, wherein the first material is a material except a metal.

According to the fourteenth embodiment, the IC tag can be reinforced without influencing transmission and reception of the tag information of the IC tag.

A fifteenth embodiment is according to the first embodiment, wherein the first material is selected from a group consisting of ABS, acrylic, polyethylene terephthalate, polystyrene and polycarbonate.

A sixteenth embodiment is according to the first embodiment, wherein the second material is selected from a group consisting of acrylic, polyester, polyvinyl chloride and elastomer.

A seventeenth embodiment is according to the first embodiment, wherein the reinforcing member is formed with a plastic.

According to the seventeenth embodiment, the IC tag can be reinforced without influencing transmission and reception of the tag information of the IC tag.

An eighteenth embodiment is according to the first embodiment, wherein the outer cover is formed with woolen yarn. For example, the stuffed toy has the outer cover that is formed by knitting woolen yarn.

According to the eighteenth embodiment, it is possible to provide a stuffed toy using woolen yarn.

A nineteenth embodiment is according to the first embodiment, and further comprises a protection member. The protection member is provided on a surface opposite to a surface that the IC tag is stuck on the reinforcing member among surfaces of the IC tag, and protects the IC tag.

According to the nineteenth embodiment, since the protection member is provided on a surface opposite to a surface that the IC tag is stuck on the reinforcing member among surfaces of the IC tag, it is possible to prevent the IC tag from being damaged even if an external force is applied from an opposite surface.

A twentieth embodiment is according to the nineteenth embodiment, wherein the protection member is transparent or semitransparent.

According to the twentieth embodiment, since the protection member is transparent or semitransparent, it is possible to prevent information indicated on a surface of the IC tag from hiding.

A twenty-first embodiment is a stuffed toy, comprising: an IC tag; a reinforcing member that is stuck with the IC tag and is formed with a first material having hardness that cannot bend at least as easily as the IC tag; an outer cover that fixes the reinforcing member and is formed with a second material softer than the first material; and an ornament member that is fixed on a surface side of the outer cover, wherein the reinforcing member is fixed so as to be sandwiched between the outer cover and the ornament member.

A twenty-second embodiment is a toy, comprising: an IC tag; a reinforcing member that fixes the IC tag and is formed with a first material having hardness that cannot bend at least as easily as the IC tag, and an outer cover that fixes the reinforcing member and is formed, at least a part, with a second material softer than the first material.

A twenty-third embodiment is a stuffed toy, comprising; an outer cover; a reinforcing member that is formed with a plastic harder than a material of the outer cover, the reinforcing member is fixed on the inner side of the outer cover and; an IC tag on the reinforcing member; the reinforcing member is located in an area corresponding to a placement portion of the stuffed toy when placing the stuffed toy on a surface.

According to each of the twenty-first to twenty-third embodiments, it is possible to prevent the IC tag from being damaged like the first embodiment.

The above described objects and other objects, features, aspects and advantages of the embodiments will become more apparent from the following detailed description when taken in conjunction with the accompanying drawings.

### BRIEF DESCRIPTION OF THE DRAWINGS

FIG. 1 is a side view of a non-limiting example toy while an appearance is viewed from a left side.

FIG. 2 includes illustration views showing an appearance of the toy shown in FIG. 1, wherein FIG. 2(A) is a front view, FIG. 2(B) is a top view, FIG. 2(C) is a bottom view and FIG. 2(D) is a rear view.

FIG. 3 is a sectional view of the toy shown in FIG. 2(A) at a line III-III.

FIG. 4(A) is an enlarged view that a part of FIG. 3 is enlarged, and FIG. 4(B) is an illustration view showing a non-limiting example reinforcing member shown in FIG. 4(A) and a non-limiting example IC tag stuck on this reinforcing member while viewing from a side of the IC tag.

FIG. 5(A) is an illustration view showing one surface (tag surface) of the IC tag shown in FIG. 4(B), and FIG. 5(B) is an illustration view showing the other surface (label surface) of this IC tag.

FIG. 6 is a sectional view that is a part of section of a toy of another embodiment is enlarged.

### DETAILED DESCRIPTION OF NON-LIMITING EXAMPLE EMBODIMENTS

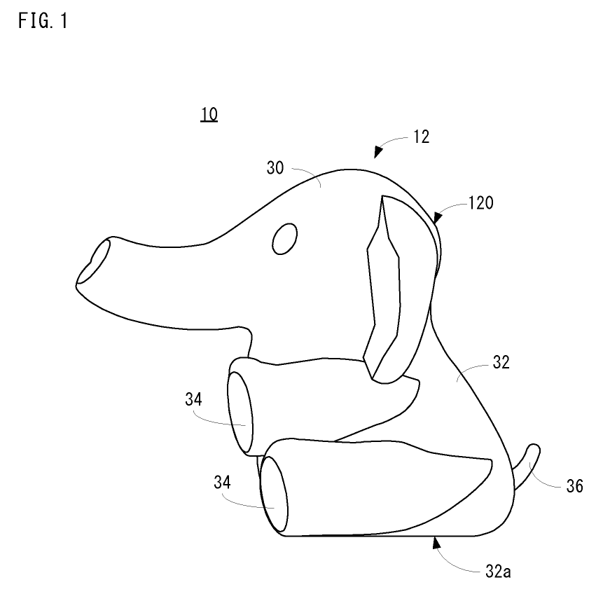

A non-limiting example toy 10 shown in FIG. 1 is a toy or doll of a soft toy type, and includes a stuffed toy 12 that has an appearance imitating a human being, an animal except a human being, a game character, an animation character, etc. In this embodiment, the stuffed toy 12 has an appearance imitating an elephant in a state of sitting down. The stuffed toy 12 comprises a head portion (including a nose and ears) 30, a body portion 32, leg portions 34 and a tail portion 36, and a portion 32a corresponding to the buttock (buttock portion) of the body portion 32 is formed in a flat surface or approximately flat surface. Therefore, if the toy 10 is placed on a plane surface, as shown in FIG. 1, it is possible to make the stuffed toy 12 sit on the plane surface down. That is, a placing portion of the toy 10 (stuffed toy 12) is formed so as to be rendered flatness or approximately flatness.

Furthermore, the stuffed toy 12 has an outer cover 120, and as described later, a filler 122 is put (filled) into inside the outer cover 120.

The outer cover 120 is formed by knitting woolen yarn, for example. A material woolen yarn may be acrylic, polyester, mixed yarn or the like. Furthermore, the filler 122 is cotton typically, and a material thereof may be acrylic or polyester. With this filler 122, an appearance shape of the outer cover 120 formed with woolen yarn can be maintained. That is, the toy 10 (stuffed toy 12) is maintained in an appearance shape imitating an elephant.

In addition, the outer cover 120 does not have to be formed all with woolen yarn, and a part thereof may be formed other woolen yarn. For example, the eyes or/and the tail portion 36 of the toy 10 (stuffed toy 12) may be formed with felt. Otherwise, the eyes may be formed with buttons.

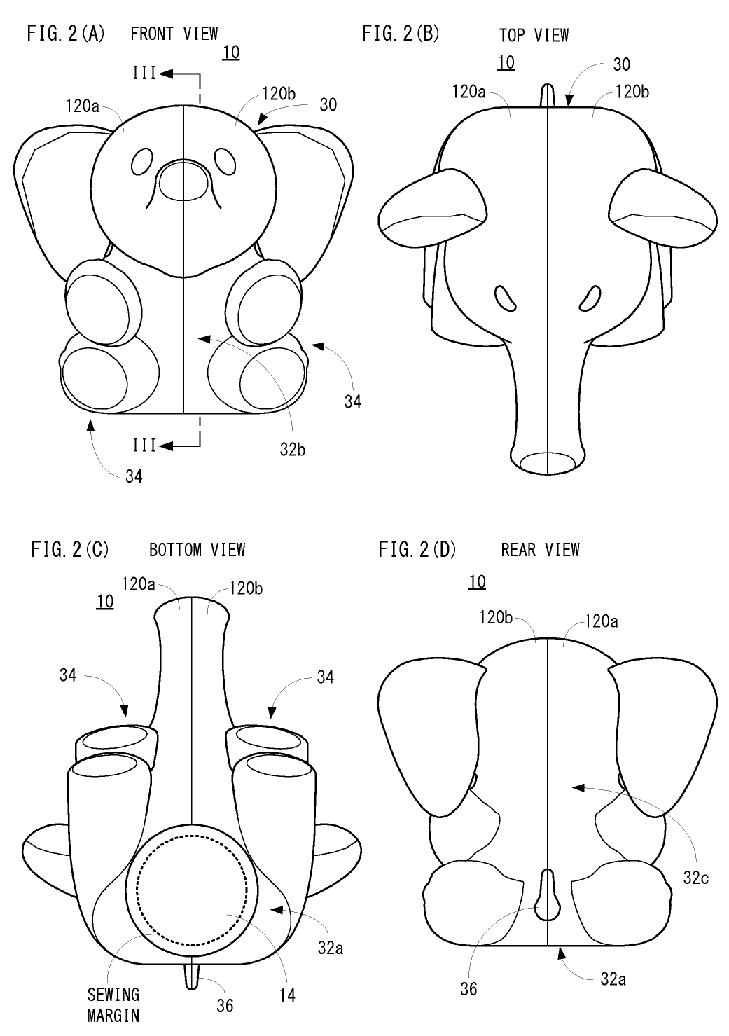

FIG. 2(A) is a front view that the toy 10 shown in FIG. 1 is viewed from the front, FIG. 2(B) is a top view that the toy 10 shown in FIG. 1 is viewed from the top, FIG. 2(C) is a bottom view that the toy 10 shown in FIG. 1 is viewed from the bottom, and FIG. 2(D) is a rear view that the toy 10 shown in FIG. 1 is viewed from the rear.

As shown in FIG. 2(A)-FIG. 2(C), in this embodiment, the outer cover 120 includes a left side member 120a and a right side member 120b, and the member 120a and the member 120b are sewn with each other. In addition, it is unnecessary to prepare the member 120a and the member 120b separately, and the member 120a and the member 120b may be a single member that the members are coupled partly. For example, as a part that the member 120a and the member 120b are coupled to each other, a part of the head portion 30 or a part of the body portion 32 (the abdominal portion 32b or the back 32c) is applicable.

Furthermore, as shown well in FIG. 2(D), a member (ornament member) 14 that is called an emblem or applique is provided (sewn) on a surface side (outer surface) of the outer cover 120 in the hips portion or buttock portion 32a of the elephant near the tail portion 36. In addition, the ornament member 14 may be embroidery directly applied to the outer cover 120. The ornament member 14 functions as an index for indicating a position to be passed over a reader/writer when passing the toy 10 over the reader/writer. For example, on the ornament member 14, a name of a manufacturer of the toy 10 and/or a name, a generic name, etc. of the toy 10 are indicated.

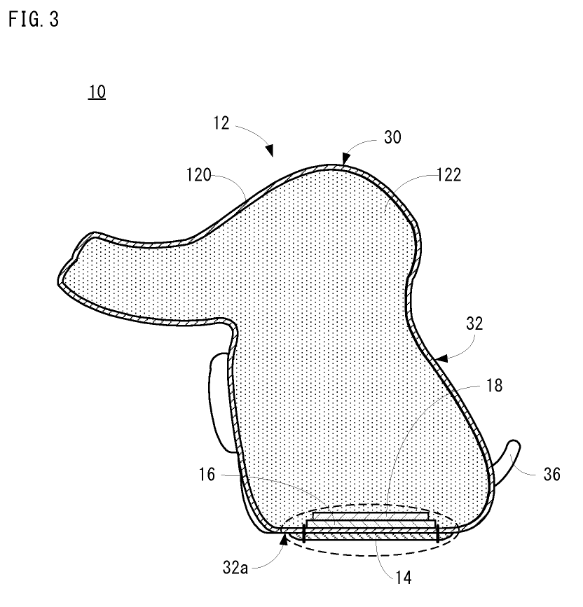

FIG. 3 is a sectional view of FIG. 2(A) at a line III-III. As shown in this FIG. 3, an inside of the outer cover 120 (toy 10) is filled with the filler 122. Furthermore, a reinforcing member 16 is fixed (provided) onto a back side (rear surface) of the outer cover 120 in a position corresponding to the ornament member 14 in the inside of the toy 10. That is, the reinforcing member 16 is fixed to the back side of a placing surface (surface of the ornament member 14 provided in the buttock portion 32a) when placing the toy 10 on a plane surface. The reinforcing member 16 is stuck on the back side of the outer cover 120 with an adhesive (hot bond), for example. Furthermore, the toy 10 includes an IC tag 18, and this IC tag 18 is fixed to the reinforcing member 16. Therefore, the IC tag 18 is provided on the back side or in an inside of the outer cover 120. Therefore, a user does not touch the IC tag 18 directly.

Since the reinforcing member 16 is thus adhered to the back side of the outer cover 120 in a position corresponding to the ornament member 14, it is possible to prevent an adhesive from exuding to the outer surface of the toy 10 by the ornament member 14. The ornament member 14 is a size comparable as the reinforcing member 16, and the ornament member 14 is somewhat larger than the reinforcing member 16 in this embodiment. Therefore, an adhesive is prevented from protruding out of the ornament member 14.

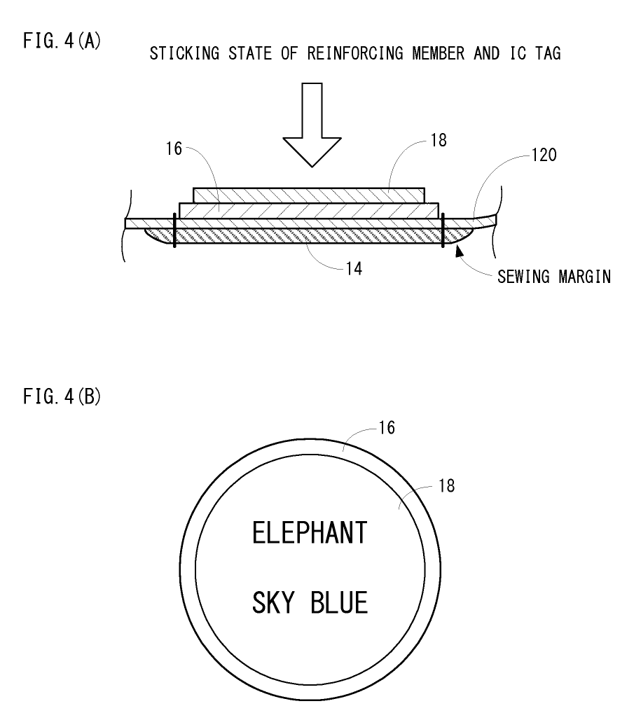

FIG. 4(A) is an enlarged view that a part of the toy 10 (portion enclosed with a dotted line) shown in FIG. 3 is enlarged, and shows a range enclosed with the dotted line of FIG. 3. FIG. 4(B) is a view that the reinforcing member 16 and the IC tag 18 stuck on the reinforcing member 16 are viewed from a side of the IC tag 18. In addition, in FIG. 4(A), the adhesive and a viscous member described later are omitted.

As shown in FIG. 4(A), in this embodiment, the ornament member 14 is stuck on the surface side of the outer cover 120, and the reinforcing member 16 is adhered onto the back side of the outer cover 120 in a position corresponding to the ornament member 14. That is, when viewing the toy 10 from the outside or inside, the ornament member 14 and the reinforcing member 16 are arranged to be overlapped with each other.

Furthermore, as shown in FIG. 4(A) and FIG. 4(B), the reinforcing member 16 is formed in a disk form, and the IC tag 18 is formed in a circular sheet form, and the reinforcing member 16 is formed slightly larger than the IC tag 18. It should be noted that in order to make it intelligible, in FIG. 4(A) (also in FIG. 3), a thickness of the IC tag 18 is illustrated as comparable to a thickness of the reinforcing member 16, but in fact, the IC tag 18 is thinner than the reinforcing member 16. This is the same in the following. Furthermore, a shape or form of each of the reinforcing member 16 and the IC tag 18 may be a polygon. In such a case, the reinforcing member 16 may be formed so as to have rounded corners. Since the outer cover would be torn if a corner of the reinforcing member 16 abuts the outer cover 120 when using the toy 10, this is for preventing the outer cover 120 from being torn. Furthermore, since the reinforcing member 16 is a disk form (tabular member), it is possible to lessen hard portions as much as possible in a deformable toy 10 such as the stuffed toy 12 while preventing damage of the IC tag 18.

The reinforcing member 16 is formed with a material except a metal and having hardness that cannot bend at least as easily as IC tag 18 or hardness that prevents the IC tag 18 from bending. Therefore, the reinforcing member 16 is harder than the outer cover 120. In this embodiment, the reinforcing member 16 may be a plastic plate and is as its material, ABS (ABS resin: generic name of acrylonitrile, butadiene and a styrene copolymerization synthetic resin), acrylics, PET (polyethylene terephthalate), PS (polystyrene), PC (polycarbonate), etc. can be adopted. A reason why the reinforcing member 16 is thus formed with a material other than a metal is to avoid affecting transmission and reception by a change of a magnetic field caused by a metal when transmitting and receiving tag information between a reader/writer and the IC tag 18. Furthermore, since the reinforcing member 16 is provided in order to make it hard to bend than the IC tag 18 at least, the reinforcing member 16 has a strength that does not bend or break easily even if a user tries to bend it.

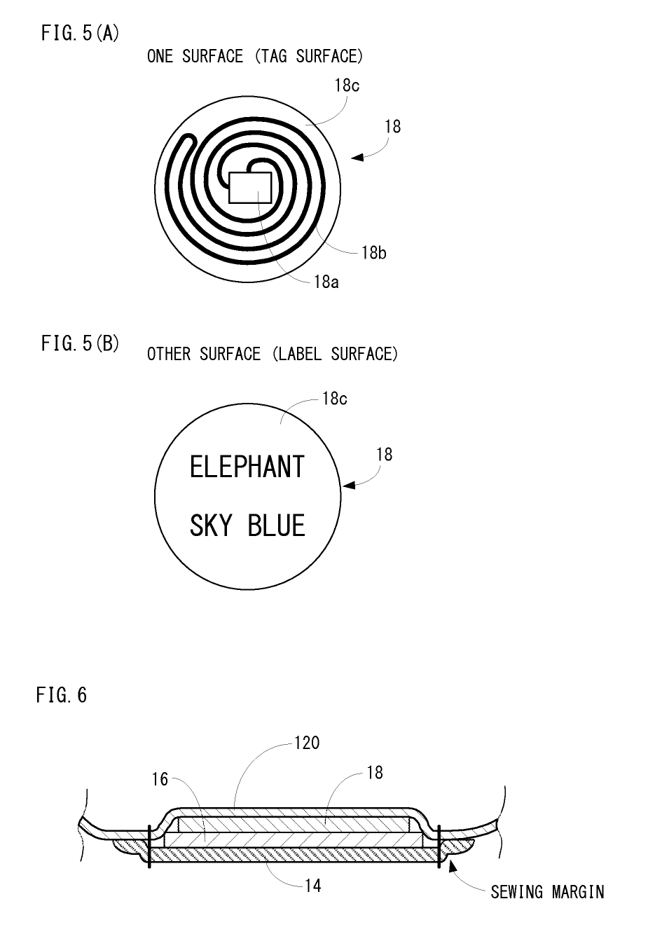

The IC tag 18 is a general-purpose passive type RFID tag, and as shown in FIG. 5(A), an IC chip 18a and an antenna 18b coupled thereto are provided on an insulating base 18c (paper or a synthetic resin, for example). On one surface (tag surface) that the IC chip 18a and the antenna 18b are provided of the IC tag 18, at least the IC chip 18a and the antenna 18b are covered by a protection coating (not shown). Furthermore, although illustration is omitted, the IC tag 18 of this embodiment is an IC tag of a label seal type, and a viscous member (paste for adhesion, for example) is provided (applied) onto a surface of the protection coating (a surface opposite to a side of the IC chip 18a and the antenna 18b) on the tag surface. Therefore, the IC tag 18 is stuck on the reinforcing member 16 by a viscous member. Furthermore, as shown in FIG. 5(B), tag information or information relevant to the tag information (written information) is indicated in the other surface that the IC chip 18a and the antenna 18b are not provided (label surface) of the IC tag 18. Here, as an example of the written information, a kind (elephant) and a color (sky blue) of the toy 10 (stuffed toy 12) are written.

Although the IC tag 18 is stuck on the reinforcing member 16 as described above, since the reinforcing member 16, the outer cover 120 and the ornament member 14 are provided between the IC tag 18 and the surface side (outside) of the toy 10 as shown in FIG. 4(A), a force from the outside is hard to be applied to the IC tag 18 and it is difficult to touch the IC tag 18 from the outside. That is, the IC tag 18 is provided in a position that is hard to be damaged.

Furthermore, since the label surface of the IC tag 18 is a surface opposite to the tag surface, even if the IC tag 18 is stuck on the reinforcing member 16, as shown in FIG. 4(B), it is possible to visually recognize the written information indicated on this label surface. Furthermore, since a surface that the IC tag 18 is not stuck thereon of the reinforcing member 16 is adhered to the back side of the outer cover 120, even if the reinforcing member 16 is adhered to the outer cover 120, it is possible to visually recognize the written information indicated on the label surface of the IC tag 18 that is stuck on the reinforcing member 16.

In addition, in either case, it is a situation that an inside of the outer cover 120 can be seen, and if it is a situation that the inside cannot be seen, the IC tag 18 itself cannot be seen.

Furthermore, although illustration is omitted, a protection member may be provided on the label surface of the IC tag 18 so as to cover the IC tag 18 at least. For example, the protection member is a transparent or semitransparent hot bond that is plastered to the IC tag 18 with a certain thickness. In another embodiment, it is possible to use a transparent or semitransparent seal made of a plastic as a protection member. Furthermore, in another embodiment, two sheets of transparent or semitransparent reinforcing members 16 are prepared such that the IC tag 18 can be provided between the two sheets of reinforcing members 16.

When thus providing the protection member, even if a pipe that is inserted into the inside of the outer cover 120 hits or rubs the IC tag 18 when filling the outer cover 120 with the filler 122, it is possible to prevent the IC tag 18 from being damaged as much as possible as describe later. A reason why the transparent or semitransparent protection member is provided is in order to prevent the written information described above from hiding.

For example, when manufacturing the toy 10 as described above, at first, the member 120a and the member 120b are sewn up with each other except for a part thereof so as to become a state where the back side of the outer cover 120 is turned outside. Except for a part near the buttock portion 32a in the abdomen 32b or the back 32c of the body portion 32, for example, the member 120a and the member 120b are sewn up with each other. Next, the outer cover 120 is turned over and the surface side of the outer cover 120 is turned outward such that the sewing margin of the member 120a and the member 120b become a back side. Subsequently, the ornament member 14 is sewn to the buttock portion 32a on the surface side of the outer cover 120. Furthermore, the reinforcing member 16 that the IC tag 18 is stuck is put into the inside the outer cover 120 from the above-described part (on the convenience of description, hereinafter, called “unsewn portion”) that the member 120a and the member 120b are not sewn up with each other. Then, the reinforcing member 16 is fixed (adhered) to the back side of the outer cover 120 in a position corresponding to the ornament member 14 by an adhesive. At this time, a surface that the IC tag 18 is not stuck thereon of the reinforcing member 16 is adhered to the back side of the outer cover 120. Then, a pipe for filling is passed through the unsewn portion, thereby to fill or pad the outer cover 120 with cotton. If the filling is completed, the unsewn portion is sewn up from the surface side of the outer cover 120.

However, if a pipe for filling is thin and thus the pipe can pass a stitch of the outer cover 120, the filling may be performed after the unsewn portion is sewn up from the surface side of the outer cover 120.

If such a toy 10 is passed over a reader/writer, tag information is read or tag information is rewritten according to instructions from a host computer. For example, the reader/writer is provided on an information processing apparatus such as a game apparatus, and arranged in a position that can read the tag information of the IC tag 18 from the front or upper side thereof when a user holds an information processing apparatus or when an information processing apparatus is placed on a plane surface of a desk etc. Furthermore, the IC tag 18 transmits and receives the tag information by performing a wireless communication in a short distance (several centimeters—several meters dependent on a frequency band). Therefore, a user passes the toy 10 over the reader/writer to be brought into contact to the reader/writer. In addition, the toy 10 may be placed on the reader/writer.

In this embodiment, the toy 10 (stuffed toy 12) has an appearance imitating an elephant, and since the buttock portion 32a of this elephant is formed with a flat surface or approximately flat surface, it is possible to make the elephant sit down. Furthermore, the ornament member 14 is provided on the buttock portion 32a of the elephant. Therefore, it is thinkable that when passing the toy 10 over a reader/writer, a user turns intuitively the buttock portion 32a of the elephant to the reader/writer. That is, by an appearance shape and the ornament member 14 of the stuffed toy 12, a user is guided so as to turn a flat surface (buttock portion 32a of the stuffed toy 12) of the toy 10 to the reader/writer. In this point, the ornament member 14 functions as an index when passing the toy 10 over a reader/writer. Furthermore, since this ornament member 14 is formed as a separate member from the outer cover 120, it is easy for a user to recognize the ornament member 14 (index). Furthermore, since the ornament member 14 is provided in the buttock portion 32a of the stuffed toy 12, the ornament member 14 cannot be visually recognized when the toy 10 is placed on a plane surface. Therefore, the ornament member 14 does not affect a design of the toy 10 (stuffed toy 12). That is, it is possible to make a user visually recognize a position of the IC tag 18 clearly, and to avoid affecting the appearance (design) of the toy 10.

Thus, the toy 10 is used in a manner that it is passed over a reader/writer, and the IC tag 18 performs a wireless communication with the reader/writer in a short distance. Therefore, in order to perform the wireless communication stably, the IC tag 18 needs to be arranged in a stable posture in the toy 10 while maintaining a certain distance with the reader/writer. Therefore, as described above, in this embodiment, the IC tag 18 is stuck on the back side of the outer cover 120 in the buttock portion 32a that is formed with a flat surface or approximately flat surface of the elephant.

In addition, if the toy 10 is relatively large, when passing the toy 10 over a reader/writer, having turned other portions (for example, the back of the leg) may be easy to pass over the toy 10 rather than turning the buttock portion 32a of the elephant to the reader/writer. In such a case, instead of the buttock portion 32a of the elephant, the IC tag 18 may be provided in a portion corresponding to a back side of a leg among the legs 34. Therefore, in this case, the ornament member 14 may be provided in a position corresponding to the back side of the leg and corresponding to a position that the IC tag 18 is provided.

According to this embodiment, since an IC tag is stuck on a reinforcing member that is formed with a material having hardness that cannot bend at least as easily as this IC tag in a toy of a soft toy type, even if an outer cover is of a relatively soft material, it is possible to make the IC tag hard to bend by a force from an outside. Therefore, it is possible to prevent an IC chip from being destroyed and an antenna from being disconnected. That is, the IC tag can be prevented from being damaged.

In addition, although the reinforcing member that the IC tag is stuck thereon is adhered to the back side of the outer cover in this embodiment, it does not need to be limited to this. For example, as shown in FIG. 6, the reinforcing member 16 that the IC tag 18 is stuck thereon may be provided (fixed) between the outer cover 120 and the ornament member 14. In such a case, since the case IC tag 18 is also stuck on the reinforcing member 16 and it is provided in the back side of the ornament member 14, it is possible to prevent the IC tag 18 from being damaged. Furthermore, the ornament member 14 and the reinforcing member 16 are comparable sizes, and since the ornament member 14 is sewn on the outer cover 120 in this case, even if the reinforcing member 16 is not adhered to the outer cover 120 and the ornament member 14, the reinforcing member 16 can be arranged stably between the outer cover 120 and the ornament member 14.

Furthermore, in this embodiment, although the protection member is adhered on the outer cover at a surface that the IC tag is not stuck thereon, a surface that the IC tag is stuck thereon may be adhered on the outer cover. Even in this way, since the IC tag is sandwiched and fixed between the adhesive and the reinforcing member, it is possible to prevent the IC tag from being damaged. However, in order to enable visual recognition of the written information, it is necessary to provide a viscous member on the label surface of the IC tag and adhere this label surface side on the reinforcing member, and further use a transparent or semitransparent reinforcing member.

Furthermore, although the outer cover is formed with the woolen yarn of material such as acrylic in this embodiment, the outer cover may be formed with a material such as polyvinyl chloride or an elastomer. In such a case, since the outer cover can maintain its appearance shape by itself, it is not necessary to put a filler such as cotton into the inside thereof. However, in this case, the air included in the inside of the outer cover is equivalent to filler.

Furthermore, although the reinforcing member is formed with a material that is hard to bend at least as easily as the IC tag in this embodiment, it does not need to be limited to this. For example, it may be sufficient that the reinforcing member is formed with the same material as the material of the base of the IC tag and thus the reinforcing member is formed so as to be hard to bend than the IC tag as a whole. That is, the reinforcing member may be formed by laminating two or more sheets of the same material as the base of the IC tag. Otherwise, the reinforcing member may be formed by enlarging the thickness of the sheet of the same material as the base of the IC tag. In addition, the reinforcing member may be formed by enlarging the thickness of the sheet of the same material as the base of the IC tag, and laminating the sheets in plural.

Furthermore, although the reinforcing member is adhered on the outer cover in this embodiment, a fixing method of the reinforcing member does not need to be limited. For example, a hole may be formed in a part of the reinforcing member such that the reinforcing member can be stitched on the outer cover. In such a case, the reinforcing member can be also fixed on the outer cover even in a portion that is not a flat surface.

Furthermore, although the ornament member that is a separate component is provided on the surface side of the outer cover in this embodiment, it does not need to be limited to this. Instead of the ornament member, a pattern or figure that becomes an index may be applied on the buttock portion of the outer cover.

Furthermore, although the IC tag is stuck on the reinforcing member in this embodiment, it does not need to be limited to this. Without using the reinforcing member, a coin type IC tag that an IC tag is covered by a casing that is formed with a material hard to bend as easily as the IC tag and has a shape of coin or a shape of disk may be fixed (adhered) to the outer cover. Otherwise, the coin type IC tag may be provided (fixed) between the ornament member and the outer cover. In this coin type IC tag, the casing functions as a reinforcing member.

Although certain example devices and equipment have been described herein, it is to be understood that the appended claims are not to be limited to the devices and equipment disclosed, but on the contrary, are intended to cover various modifications and equivalent arrangements included within the spirit and scope of the appended claims.

What is claimed is:

1. A stuffed toy, comprising;
an IC tag;
a reinforcing member that the IC tag is stuck thereon, and is formed with a first material that has hardness that is harder to bend than at least the IC tag; and
an outer cover that fixes the reinforcing member thereon, and is formed with a second material softer than the first material, wherein
the reinforcing member is fixed to a back side of the outer cover corresponding to a placement portion of the stuffed toy when placing the stuffed toy on a plane surface.

2. The stuffed toy according to claim 1, wherein the placement portion of the stuffed toy when placing the stuffed toy on a plane surface is formed so as to become a flat surface or approximately flat surface.

3. The stuffed toy according to claim 1, wherein the reinforcing member is fixed to a back side of a buttock portion of the stuffed toy.

4. The stuffed toy according to claim 1, further comprising an index that is provided on a surface side of the outer cover corresponding to the reinforcing member.

5. The stuffed toy according to claim 4, wherein the index is formed by an ornament member that is a separate member fixed to the outer cover.

6. The stuffed toy according to claim 5, wherein the reinforcing member is adhered to a portion that the ornament member is provided of a back side of the outer cover.

7. The stuffed toy according to claim 1, wherein the reinforcing member is fixed to a back side of the outer cover, and the IC tag is stuck on a surface opposite to a surface facing the outer cover among surfaces of the reinforcing member when fixed to the outer cover.

8. The stuffed toy according to claim 1, wherein the IC tag is an IC tag with a viscous agent.

9. The stuffed toy according to claim 1, further comprising filler that is filled inside the outer cover.

10. The stuffed toy according to claim 9, wherein a material of the filler is acrylic or polyester.

11. The stuffed toy according to claim 1, wherein the reinforcing member is a plate-like member.

12. The stuffed toy according to claim 1, wherein the reinforcing member is formed in a polygon with rounded corners or a circle.

13. The stuffed toy according to claim 1, wherein the first material has hardness that can prevent the IC tag from bending in a state where the IC tag is stuck on the reinforcing member.

14. The stuffed toy according to claim 1, wherein the first material is a material except a metal.

15. The stuffed toy according to claim 1, wherein the first material is selected from a group consisting of ABS, acrylic, polyethylene terephthalate, polystyrene and polycarbonate.

16. The stuffed toy according to claim 1, wherein the second material is selected from a group consisting of acrylic, polyester, polyvinyl chloride and elastomer.

17. The stuffed toy according to claim 1, wherein the reinforcing member is formed with a plastic.

18. The stuffed toy according to claim 1, wherein the outer cover is formed with woolen yarn.

19. The stuffed toy according to claim 1, further comprising a protection member that is provided on a surface opposite to a surface that the IC tag is stuck on the reinforcing member among surfaces of the IC tag, and protects the IC tag.

20. The stuffed toy according to claim 19, wherein the protection member is transparent or semitransparent.

21. A stuffed toy, comprising:
an IC tag;
a reinforcing member that is stuck with the IC tag and is formed with a first material having hardness that cannot bend at least as easily as the IC tag;
an outer cover that fixes the reinforcing member and is formed with a second material softer than the first material; and
an ornament member that is fixed on a surface side of the outer cover, wherein the reinforcing member is fixed so as to be sandwiched between the outer cover and the ornament member.

22. A toy, comprising:
an IC tag;
a reinforcing member that fixes the IC tag and is formed with a first material having hardness that cannot bend at least as easily as the IC tag, and
an outer cover that fixes the reinforcing member and is formed, at least a part, with a second material softer than the first material.

23. A stuffed toy, comprising;
an outer cover;
a reinforcing member that is formed with a plastic harder than a material of the outer cover, the reinforcing member is fixed on the inner side of the outer cover and;
an IC tag on the reinforcing member;
the reinforcing member is located in an area corresponding to a placement portion of the stuffed toy when placing the stuffed toy on a surface.
